(19) United States
(12) Patent Application Publication
(10) Pub. No.: US 2015/0220111 A1
(43) Pub. Date: Aug. 6, 2015

(54) Electronic Device with Display Manager, Folio with Secondary Display, and Methods Therefor

(71) Applicant: Google Technology Holdings LLC, Mountain View, CA (US)

(72) Inventor: Michael David McLaughlin, San Jose, CA (US)

(21) Appl. No.: 14/183,022

(22) Filed: Feb. 18, 2014

Related U.S. Application Data
(60) Provisional application No. 61/934,485, filed on Jan. 31, 2014.

(51) Int. Cl. G06F 1/16; G06F 3/041

(52) U.S. Cl. CPC G06F 1/1618; G06F 3/0412; G06F 1/1641; G06F 1/1643; G06F 1/1654; G06F 1/1647; G06F 1/1652; G06F 2203/04101

(57) ABSTRACT

A system includes an electronic device and an interface accessory. The electronic device includes a housing and a display disposed along a major face of the housing. A control circuit, which can be one or more circuits, is operable to present information on the display. The interface accessory attaches to the housing. The interface accessory has a cover and a charged pigment display disposed along an exterior of the cover. The cover is foldable to conceal the display. The control circuit can replicate the information on the display to the charged pigment display.

### CROSS REFERENCE TO PRIOR APPLICATIONS

This application claims priority and benefit under 35 U.S.C. §119(e) from U.S. Provisional Application No. 61/934,485, filed Jan. 31, 2014, which is incorporated by reference for all purposes.

### BACKGROUND

1. Technical Field

This disclosure relates generally to accessories, and more particularly to accessories for electronic devices.

2. Background Art

Mobile electronic communication devices, such as mobile telephones, smart phones, gaming devices, and the like, are used by billions of people. The owners of such devices come from all walks of life. These owners use mobile communication devices for many different purposes including, but not limited to, voice communications, text messaging, Internet browsing, commerce such as banking, and social networking. The circumstances under which users of mobile communication device use their devices varies widely as well.

As these devices have become more sophisticated, so too have their displays and the information that can be presented on them. For example, not too long ago a mobile phone included a rudimentary light emitting diode display capable of only presenting numbers and letters configured as seven-segment characters. Today, high-resolution liquid crystal and other displays included with mobile communication devices and smart phones can be capable of presenting high-resolution video.

Modern high-resolution liquid crystal and other displays are not without their issues, however. For example, high-resolution displays consume relatively more power than do simple, low-resolution displays. Additionally, some high-resolution displays can be difficult to see in every environment. As they frequently employ light transmission to create images, they may be challenging to see in full sun, for example. It would be advantageous to be able to take advantage of a high-resolution display while solving some of these issues as well.

### BRIEF DESCRIPTION OF THE DRAWINGS

FIG. 1 illustrates one explanatory electronic device in accordance with one or more embodiments of the disclosure.

FIG. 2 illustrates one explanatory interface accessory in accordance with one or more embodiments of the disclosure.

FIG. 3 illustrates one explanatory system in accordance with one or more embodiments of the disclosure.

FIG. 4 illustrates another explanatory interface accessory in accordance with one or more embodiments of the disclosure.

FIG. 5 illustrates one explanatory system diagram in accordance with one or more embodiments of the disclosure.

FIG. 6 illustrates one example of a charged pigment display in accordance with one or more embodiments of the disclosure.

FIG. 7 illustrates another explanatory interface accessory in accordance with one or more embodiments of the disclosure.

FIG. 8 illustrates another explanatory interface accessory in accordance with one or more embodiments of the disclosure.

FIG. 9 illustrates another explanatory system in accordance with one or more embodiments of the disclosure.

FIG. 10 illustrates portions of one explanatory method in accordance with one or more embodiments of the disclosure.

FIG. 11 illustrates portions of one explanatory method in accordance with one or more embodiments of the disclosure.

FIG. 12 illustrates portions of one explanatory method in accordance with one or more embodiments of the disclosure.

FIG. 13 illustrates portions of one explanatory method in accordance with one or more embodiments of the disclosure.

FIG. 14 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to an interface accessory suitable for use with an electronic device to form a system as described herein. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of an interface accessory operating in communication to present images on a charged pigment display of the interface accessory as described herein. The non-processor circuits may include, but are not limited to, a radio receiver, a radio transmitter, signal drivers, clock circuits, power source circuits, and user input devices. As such, these functions may be interpreted as steps of a method to perform the presentation of images on a charged pigment display of an interface accessory when coupled to, and in communication with, an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present disclosure provide an interface accessory suitable for use with an electronic device, such as a mobile communication device, gaming device, and the like. The interface accessory includes an attachment portion to attach to a housing of the electronic device. A cover of the interface accessory is movable to selectively cover and conceal a display of the electronic device. In one or more embodiments, the cover includes a charged pigment display disposed along an exterior portion of the cover. One or more circuits, which are operable with the charged pigment display, are operable to receive display presentation instructions form the electronic device. When the cover conceals the primary display of the electronic device, the one or more circuits can replicate presentation information from the primary display on the charged pigment display.

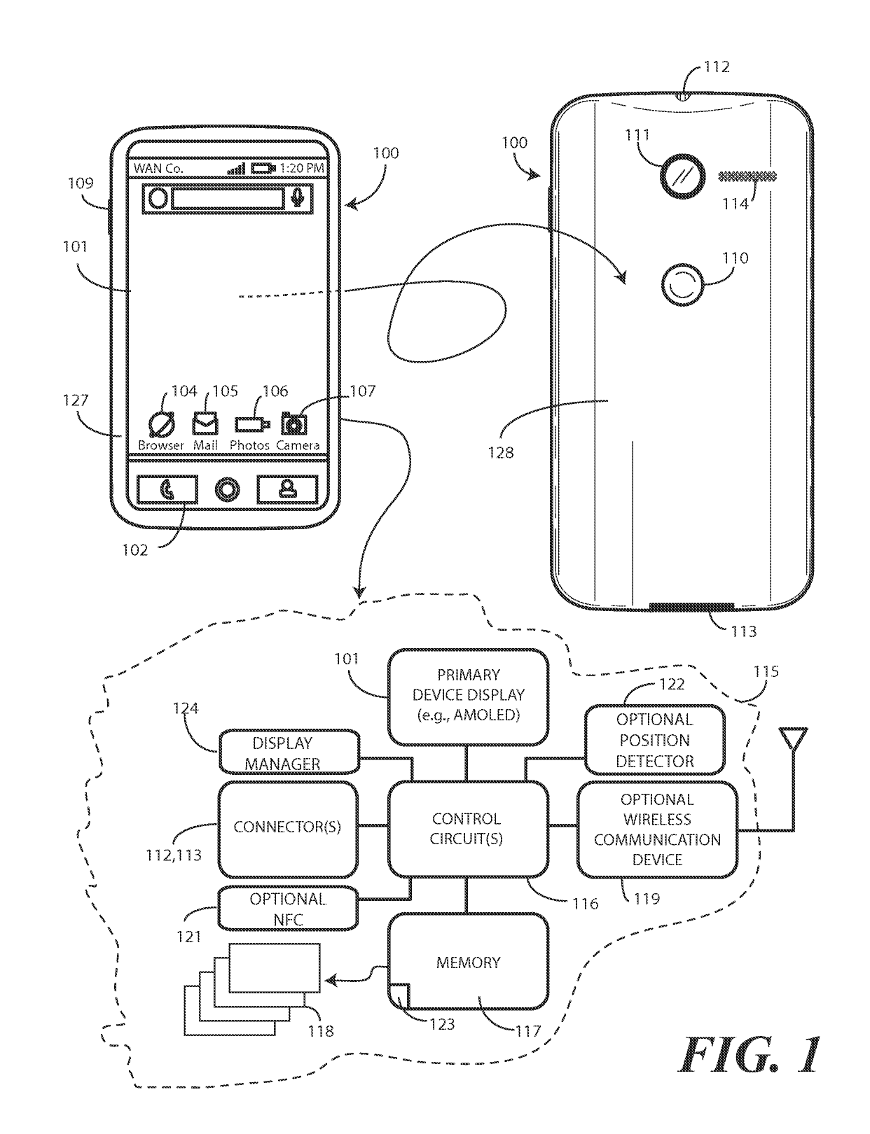

Turning now to FIG. 1, illustrated therein is one explanatory electronic device 100 configured in accordance with one or more embodiments of the disclosure. The explanatory electronic device 100 of FIG. 1 is shown as a smart phone for illustrative purposes. However, it will be obvious to those of ordinary skill in the art having the benefit of this disclosure that other electronic devices may be substituted for the explanatory smart phone of FIG. 1. For example, the electronic device 100 may be configured as a palm-top computer, a tablet computer, a gaming device, wearable computer, a media player, or other device.

This illustrative electronic device 100 includes a display 101, which may optionally be touch-sensitive. In one embodiment, the display 101 is configured as an active matrix organic light emitting diode (AMOLED) display. However, it should be noted that other types of displays, including liquid crystal displays, would be obvious to those of ordinary skill in the art having the benefit of this disclosure.

In one embodiment, the display 101 is a high-resolution display. The term “high-resolution display” is used herein to refer to a display device that can present text and images to a user by altering a large number of pixels which, when viewed collectively by a user, form the presented text or image. The high-resolution display can be used for the presentation of text, information, and graphics on a mobile device with sufficient granularity as to be easily switched between graphics or text. For example, the high-resolution display could be one suitable for presenting an image in the Joint Photographics Expert Group (JPG) format to the user. Such displays generally are configured to turn on and off individual pixels by way of a display driver for the presentation of high-resolution information.

The explanatory electronic device 100 of FIG. 1 includes two housing members. An upper housing member 127 is disposed about the periphery of the display 101. Said differently, the display 101 is disposed along a major face of the upper housing member 127 in one embodiment. A rear housing 128 forms the backside of the electronic device 100 in this illustrative embodiment. Features can be incorporated into the housing members, including optional control buttons 109,110, an optional camera 111, and an optional speaker port 114.

In one embodiment, the electronic device 100 includes one or more connectors 112, 113, which can include an analog connector, a digital connector, or combinations thereof. In this illustrative embodiment, connector 112 is an analog connector disposed on a first edge, i.e., the top edge, of the electronic device 100, while connector 113 is a digital connector disposed on a second edge opposite the first edge, which is the bottom edge in this embodiment.

A block diagram schematic 115 of the electronic device 100 is also shown in FIG. 1. In one embodiment, the electronic device 100 includes one or more control circuits, shown illustratively as control circuit 116. Control circuit 116 can include one or more processors. The control circuit 116 can be responsible for performing the various functions of the electronic device 100. The control circuit 116 can be a microprocessor, a group of processing components, one or more Application Specific Integrated Circuits (ASICs), programmable logic, or other type of processing device. The control circuit 116 can be operable with the various components of the electronic device 100. For example, in one embodiment the control circuit 116 comprises one or more circuits operable to present presentation information, such as images, text, and video, on the display 101.

The control circuit 116 can be configured to process and execute executable software code to perform the various functions of the electronic device 100. For example, the control circuit 116 can be operable with the display 101 to present information on the display 101. A storage device, such as memory 117, stores the executable software code used by the control circuit 116 for device operation. The executable software code used by the control circuit 116 can be configured as one or more modules 118 that are operable with the control circuit 116. Such modules 118 can store instructions, control algorithms, and so forth. The instructions can instruct processors or control circuit 116 to perform the various steps of the methods described herein.

The operating system environment, which is configured as executable code operating on one or more processors or control circuits of the electronic device 100, has associated therewith various applications or “apps.” Examples of such applications shown in FIG. 1 include a cellular telephone application 102 for making voice telephone calls, a web browsing application 105 configured to allow the user to view webpages on the display 101 of the electronic device 100, an electronic mail application 106 configured to send and receive electronic mail, a photo application 107 configured to permit the user to view images or video on the display 101 of electronic device 100, and a camera application 108 configured to capture still (and optionally video) images. These applications are illustrative only, as others will be obvious to one of ordinary skill in the art having the benefit of this disclosure.

In this illustrative embodiment, the electronic device 100 also includes a communication circuit 119 that can be configured for wired or wireless communication with one or more other devices or networks. The networks can include a wide area network, a local area network, and/or personal area network. Examples of wide area networks include GSM, CDMA, W-CDMA, CDMA-2000, iDEN, TDMA, 2.5 Generation 3GPP GSM networks, 3rd Generation 3GPP WCDMA networks, 3GPP Long Term Evolution (LTE) networks, and 3GPP2 CDMA communication networks, UMTS networks, E-UTRA networks, and other networks. The communication circuit 119 can include wireless communication circuitry, one of a receiver, a transmitter, or transceiver, and one or more antennas 120.

In one embodiment, the electronic device 100 also includes an optional near field communication circuit 121. The near field communication circuit 121 can be operable with the control circuit 116 to permit the electronic device 100 to communicate with other near field communication devices. For example, in one embodiment described below, the near field communication circuit 121 can be used to detect, and communicate with, an interface accessory when the attachment portion of the interface accessory is attached to the housing 127,128 of the electronic device 100. This application for the near field communication circuit 121 is illustrative only, as others will be obvious to one of ordinary skill in the art having the benefit of this disclosure.

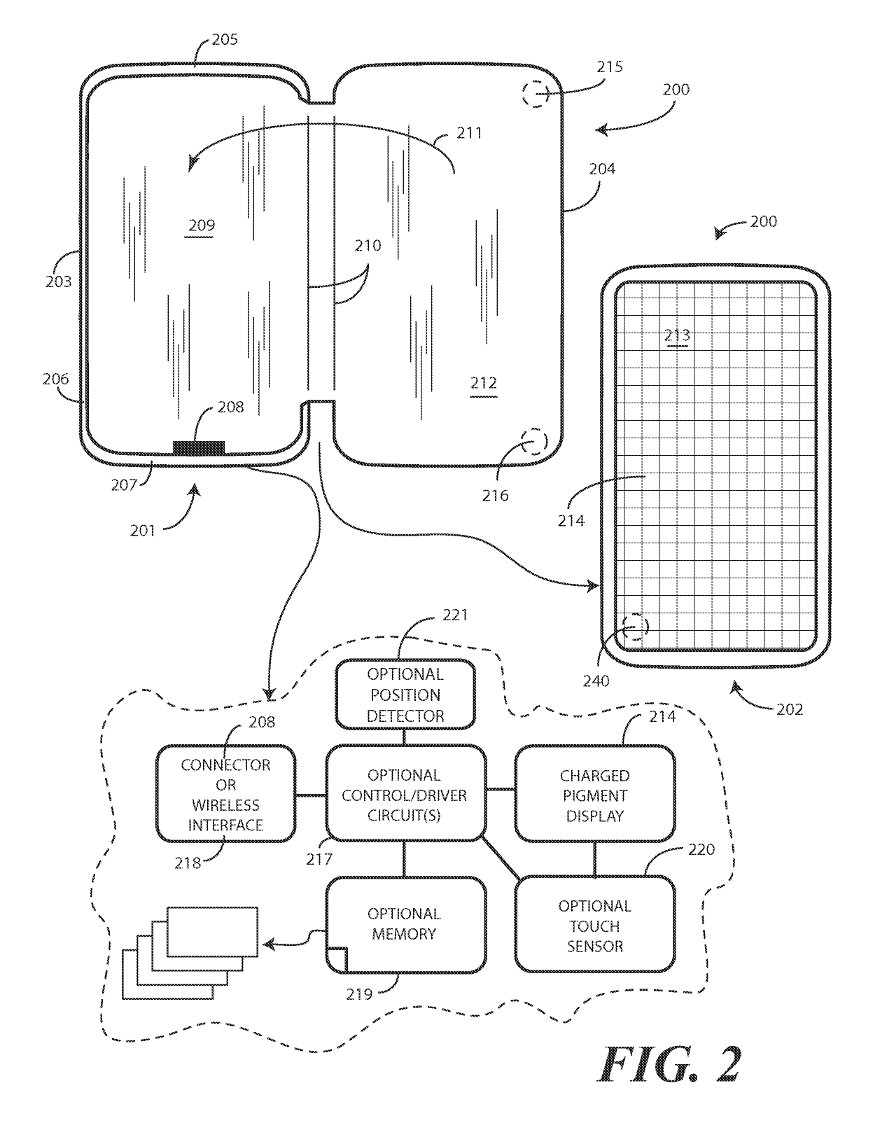

In one embodiment, the near field communication circuit 121 is operable with a wireless near field communication transceiver, which in one embodiment is a form of radio-frequency device configured to send and receive radio-frequency data to remote near field communication devices or to the interface accessory (shown in FIG. 2). The near field communication circuit 121 can have its own near field communication circuit controller in one or more embodiments to wirelessly communicate with a variety of near field communication devices employing various near field communication technologies and protocols. The near field communication circuit 121 can include—as an antenna—a communication coil that is configured for near-field communication at a particular communication frequency. In one embodiment, the communication coil is wrapped about a ferrite or other material. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data.

Turning now to FIG. 2, illustrated therein is one embodiment of an interface accessory 200 configured in accordance with one or more embodiments of the disclosure. In FIG. 2, the interface accessory 200 is shown in an open configuration at 201 and in a closed configuration at 202.

The illustrative interface accessory 200 includes an attachment portion 203 and a cover 204. The attachment portion 203 is to attach to a housing (127,128) of the electronic device (100). In this illustrative embodiment, the attachment portion 203 is configured as a compartment to receive the electronic device (100). This results in the interface accessory 200 being configured as a case or protective covering for the electronic device (100). For example, in one embodiment, the attachment portion 203 includes three side members 205,206,207 that extend from a rear panel 209 of the attachment portion and wrap about the sides of the electronic device (100) to mechanically attach to the housing (127,128) of the electronic device 100. A complementary connector 208 is included for attachment to the connector (113) of the electronic device (100).

The cover 204 is foldable 211 relative to the attachment portion 203 in one or more embodiments. In one embodiment, the cover 204 is foldable 211 relative to the attachment portion 203 about about an interconnection axis. In the illustrative embodiment of FIG. 2, the cover 204 is foldable about a pair of interconnection axes 210 relative to the attachment portion. Accordingly, the cover 204 is movable from a radially displaced, open position relative to the attachment portion 203 as shown at 201, to a closed position as shown at 202. When in the open position, an interior portion 212 of the cover 204 is visible to a user. Likewise, when in the closed position, an exterior portion 213 of the cover 204 is visible to the user. The cover 204 is thus capable of concealing the display (101) of an electronic device (100) when the housing (127,128) of the electronic device (100) is attached to the attachment portion 203 and the cover 204 is folded about the interconnection axes 210 to the closed position.

In one or more embodiments, the cover 204 comprises a charged pigment display 214 disposed along the exterior portion 213 of the cover 204. Note that a charged pigment display 214 is but one type of display suitable for use on the cover 204. AMOLED displays and other types of displays can be used as well. In one embodiment, the charged pigment display 214 is coupled with the complementary connector 208 such that data and other information can be communicated to the charged pigment display 214 through the complementary connector 208. As will be described in more detail below, in one or more embodiments the charged pigment display 214 is wirelessly coupled with the control circuit (116) of the electronic device (100) such that data and other information can be communicated to the charged pigment display 214. This wireless connection could be via a wireless protocol, such as Bluetooth.sup™ or Wi-Fi. Where the interface accessory 200 is configured as a case for an electronic device (100), the data communication through the complementary connector 208 may be advantageous. However, in other applications, such as where the interface accessory 200 is configured as a wearable device, the wireless communication may me more advantageous.

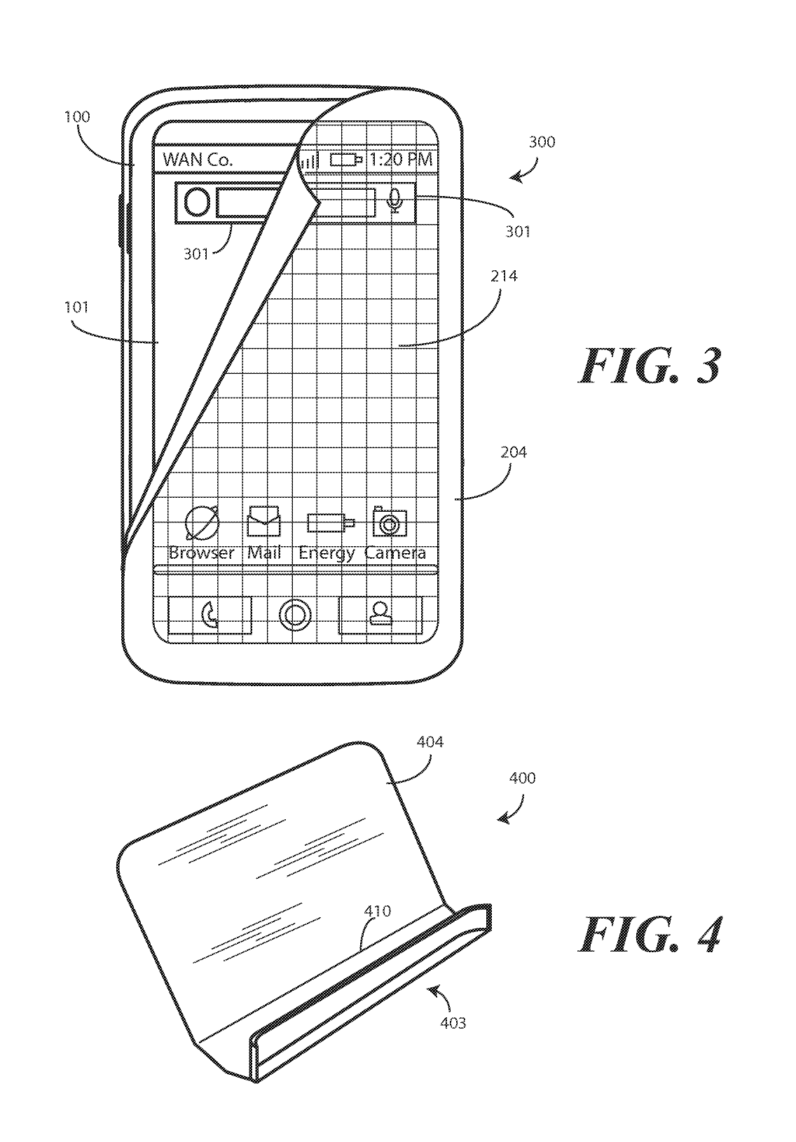

The charged pigment display 214 may be an electrophoretic or electronic-ink device. It will be clear to those of ordinary skill in the art having the benefit of this disclosure that the invention is not so limited. Other devices, including those operating by moving particles electrophoretically in gels, powders, gasses, or other transfer media, may also be used. In one embodiment, as shown in FIG. 3 below, the charged pigment display 214 can be pliable so as to easily bend when the cover 204 is moved about the interconnection axes 210. Where the charged pigment display 214 is a pliant display device, the cover 204 can be configured to be correspondingly pliable so that the two elements can bend in unison as a single unit.

Electrophoretic displays are manufactured by suspending particles in a medium, examples of which include gas, liquid, or gel, between two substrates. The particles may optionally be encapsulated in small capsules that are held between the walls, or they may be emulsified in a polymeric matrix. The particles have optical properties that are different from the medium in which they are suspended. Due to the electrochemical properties of the particles, and of the medium, the particles spontaneously acquire a net charge when placed in the medium. Having a charge, the particles will move in the presence of an externally applied electric field. Transparent electrodes, generally manufactured by depositing indium-tin oxide (In.sub.2O.sub.3-SnO.sub.2), often in the shape of pixels, apply selective electric fields to the particles, thereby causing the particles to rotate and move to the viewable display surface. This movement causes an image to appear at the viewable display surface. Electrophoretic displays tend to be both very efficient in terms of electrical current consumption. Further they are generally available at a reasonable cost.

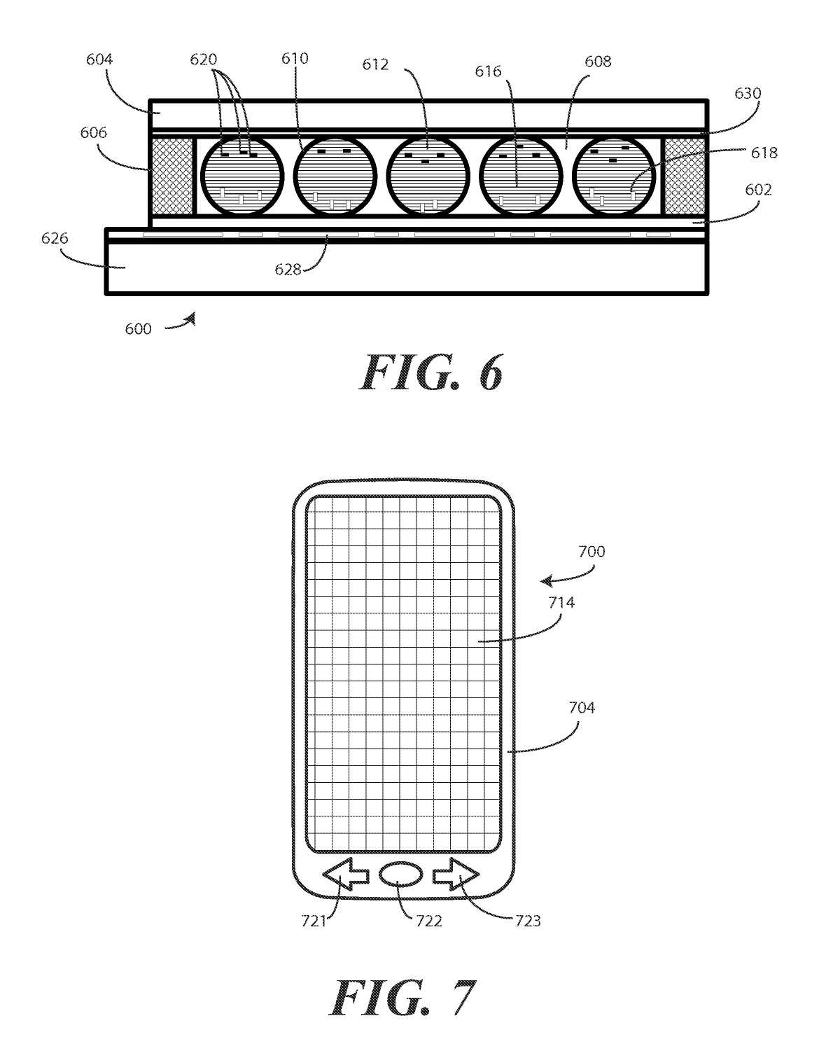

Turning briefly to FIG. 6, illustrated therein is one example of a sectional view of a charged pigment display 600. This explanatory charged pigment display 600 is suitable for use as the charged pigment display (214) of FIG. 2, although numerous other charged pigment, electrophoretic, or electronic ink technologies could be substituted therefor. In this illustrative embodiment, the charged pigment display 600 includes a lamination adhesive 602 coupling a thin film transistor backplane 626 and a transparent front substrate 604. An adhesive 606 is generally employed to bond and seal the perimeters of the lamination adhesive 602 and the front substrate 604, thereby forming a chamber 608.

A plurality of capsules 610,612 is disposed within in the chamber 608. Each of the capsules 610,612 encloses a medium 616, such as hydrocarbon oil in liquid-based electrophoretic materials, with light and dark particles 618,620 suspended therein. Some of these particles 618, which may be made from titanium dioxide, are generally white (i.e. reflective across the visible spectrum). Other particles 620 may be pigmented with a dark colored dye so as to appear black. (Other color schemes, resulting from slightly different chemistries, may also be used.) With surfactants and charging agents, the white particles 618 are positively charged while the black particles 620 are negatively charged.

The front substrate 604 is a transparent substrate that is tied electrically to ground or a common node by a layer of transparent electrode material 630, such as indium-tin oxide. When an electric field is applied to electrodes 628 disposed along the back substrate by one or more control circuits, the particles 618,620 migrate electrophoretically so as to form an image viewable to the user. For example, when the white particles 618 move to the top of the capsule 610 they become visible as the color white to the user from the front side. At the same time, the electric field pulls the black particles 620 to the bottom of the capsules 610 where they are hidden. By reversing this process, the black particles 620 appear at the top of the capsule 610, which becomes visible as the color black. In such a manner, the one or more control circuits can be configured to selectively present presentation information to a user by rearranging the charged pigment particles 618,620 with an applied electric field.

Turning now back to FIG. 2, as noted above, the interface accessory 200 can be configured to attach to an electronic device, such as the electronic device (100) of FIG. 1. By placing the electronic device (100) into the compartment formed by the rear panel 209 and the three sidewalls 205,206,207, a system can be formed. When the electronic device (100) is placed into the compartment, the complementary connector 208 of the interface accessory 200 can attach to the corresponding connector (113) of the electronic device (100). Such a system 300 is shown in FIG. 3.

Turning now to FIG. 3, the system 300 comprises the electronic device 100 and the interface accessory 200. As shown in this illustrative embodiment, the interface accessory 200 serves as a protective case for the electronic device 100. When the cover 204 is in the open position, a user may interact with the electronic device 100 normally. For example, the user can deliver touch input to the display 101 to control the operation of the electronic device 100, and so forth.

Advantageously, when the cover 204 is moved to the closed position, the control circuit (116) of the electronic device 100 can deliver presentation instructions from the electronic device 100, through the connector (113) and complementary connector (208), or optionally through a wireless connection, to replicate presentation information 301 from the display 101 on the charged pigment display 214. In one embodiment, this replication occurs when the complementary connector (208) is coupled to the connector (113). Thus, use of the interface accessory 200 allows a user to have the best of both worlds with respect to display technology: an AMOLED (for example) display when the cover 204 is in the open position and an electronic ink (for example) display when the cover 204 is folded to the closed position so as to conceal the display 101.

The provision of a dual display technology system 300 as shown in three offers numerous advantages for a user. While AMOLED displays and other light emitting diode displays are lightweight, have excellent contrast ratios, and perform fabulously in normal and low-light environments, they can be difficult to see in full sun. By contrast, electronic ink displays are easily visible in the sun, as they use reflected ambient light instead of transmitting light from a light source. Accordingly, a user may fold the cover 204 to the open position when indoors or in low light environments, but filed the cover 204 to the closed position in bright light or sunny conditions.

Second, some professionals suggest that two much light projected into the eyes prior to bedtime can alter sleep patterns. Accordingly, a user may simply close the cover 204 to use the charged pigment display 214 for reading prior to bedtime to reduce projected light.

Third, by placing the charged pigment display on the exterior portion (213) of the cover 204, the interface accessory 200 not only provides a second display technology for the user, but also acts as a protective cover for the display 101 when concealing the display. Accordingly, the user is less likely to damage the display 101 as a result of dropping the system 300 or other mishaps.

Fourth, the charged pigment display 214 tends to use less power than a light emitting display. This is true for at least two reasons: First, unlike light emitting diode displays, the charged pigment display 214 does not require a backlight. Second, once the capsules (610,612) are moved into position to render presentation information on the charged pigment display, the capsules (610,612) stay in this orientation until they are again moved. Accordingly, the charged pigment display 214 can use less power by only selectively moving the capsules (610,612) and by not requiring the necessary power to operate a backlighting system. This translates into an advantage for the user in that the user can extend the battery life of the electronic device 100 by closing the cover 204 and using the charged pigment display 214 to view notifications, the time of day, electronic mail communication, electronic messages, web pages, electronic books, and so forth.

The system 300 of FIG. 3 can function in multiple ways. For example, in one embodiment, the control circuit (116) of the electronic device 100 can be operable with the charged pigment display 214 to deliver presentation instructions from the electronic device 100, through the connector (113) and complementary connector (208), to replicate presentation information 301 from the display 101 on the charged pigment display 214. In another embodiment, the interface accessory 200 can include one or more control circuits, which are operable with the charged pigment display 214, to receive presentation instructions from the electronic device 100 through the connector (113) and complementary connector (208) to replicate presentation information 301 from the display 101 on the charged pigment display 214. Additionally, positional detectors, which can be disposed in either the electronic device 100 or the interface accessory 200, can detect rotational alignment of the cover 204 relative to the attachment portion (203) to communicate rotational alignment to the control circuit (116) of the electronic device 100 so that the presentation instructions can be delivered automatically to cause replication of the presentation information 301 from the display 101 on the charged pigment display 214 when the cover 204 conceals the display 101, and optionally to place the display 101 in a low-power or sleep mode.

Illustrating by example, referring again to FIG. 1, in one embodiment the electronic device 100 includes an optional position detector 122 to detect a rotational alignment of the cover (204) relative to the attachment portion (203) of the interface accessory (200). The position detector 122 can then communicate the detected rotational alignment to the control circuit 116 of the electronic device 100. For instance, in one embodiment, the position detector 122 detects that a magnet (215,216) integrated with the cover (204) of the interface accessory (200) is in close proximity with, or abutting, the upper housing member 127 of the electronic device 100. This indicates that the cover (204) is in a closed position. In another embodiment, rather than detecting a magnet (215,216), a low-power infrared transceiver can detect reflections from the cover (204) to determine whether it is in a closed position. Other techniques for determining when the cover (204) of the interface accessory (200) is closed will be obvious to those of ordinary skill in the art having the benefit of this disclosure.

When this occurs, the control circuit 116 of the electronic device 100 can deliver presentation instructions from the electronic device 100, through the connector 113 and complementary connector (208), to replicate presentation information (301) from the display 101 on the charged pigment display (214). In one embodiment, this replication of the presentation information (301) on the charged pigment display 214 occurs automatically when the position detector 122 detects that the cover (204) conceals the display 101. In one embodiment, the control circuit 116 can replicate the presentation information (301) from the display 101 on the charged pigment display only when the cover (204) conceals the display 101.

It should be noted that when the cover (204) conceals the display 101, there is no longer a need to present the presentation information (301) on the display. This is true because the display 101 is no longer visible to the user. Accordingly, in one embodiment the control circuit 116 of the electronic device is to place the display 101 in a low power, sleep, or hibernate mode when the position detector 122 determines that the cover (204) conceals the display 101.

It should be noted that embodiments described above refer to “replicating” information from the display 101 to the charged pigment display (214). As used herein, the term “replicating” means to present the same presentation information (301) on the charged pigment display (214) that would be, or is being, presented on the display 101. Thus, as used herein, “replicating” includes transferring the presentation information (301) to the charged pigment display (214), in that the same information that was being presented on the display 101 is now being presented on the charged pigment display (214). This transferring can occur when, for example, the display is placed into a low-power or sleep mode and the presentation information (301) on the display 101 just prior to the low power or sleep mode is thereafter being presented on the charged pigment display (214).

In one or more embodiments, replicating includes embodiments where the presentation information (301) has not been truncated, cut, reduced, or altered in any way. Advantageously, the user is able to see the exact same presentation information on the charged pigment display (214) that they would on the display. This is in contrast to prior art applications that scale, cut, truncate, and alter information through an application to present that information on a secondary display. To accomplish a more realistic replication, in one embodiment the resolution of the charged pigment display (214) and the display 101 are the same. Thus, if the display 101 is a 256 pixel by 128 pixel reflective or backlit AMOLED display, the charged pigment display (214) may be a 256 pixel by 128 pixel electronic ink display, and so forth.

In other embodiments, “pseudo-replication” is employed. In pseudo-replication, there is not a one-for-one pixel replication of information. The display manager 124 instead renders the same presentation information (301) that was presented on the display 101, without truncation, cutting, or reduction, but does so according to the display aspect ratio, color capability, refresh rate, and pixel resolution of the charged pigment display (214). Embodiments of the disclosure contemplate both replication and pseudo replication because different technologies can be used for the charged pigment display (214). Illustrating by example, an electronic ink display may differ from an AMOLED display in aspect ratio, color capability, refresh rate, and pixel resolution. Consequently, while replication may be suitable for one technology, pseudo-replication may be more appropriate for a different technology. Accordingly, in one or more embodiments the display manager 124 can consider the technological capabilities of the charged pigment display (214) render the presentation information (301) so as to be properly viewable on the charged pigment display (214).

In one or more embodiments, the connector 113 and the complementary connector (208) of the interface accessory (200) can be replaced with a wireless connection. For example, the near field communication circuit 121 of the electronic device 100 can communicate with a wireless interface (218) of the interface accessory (200). Accordingly, the control circuit 116 of the electronic device 100 can wirelessly transmit display presentation instructions 123 from the electronic device 100 to replicate presentation information (301) from the display 101 on the charged pigment display (214) of the interface accessory (200) in one or more embodiments.

Referring again to FIG. 2, in one or more embodiments the interface accessory 200 can optionally include one or more control or driver circuits 217 to receive display presentation instructions (123) from the electronic device (100) to replicate presentation information (301) from the display (101) on the charged pigment display 214. A storage device, such as memory 219, can optionally be included with the interface accessory 200 to store executable software code used by the one or more control or driver circuits 217 for device operation. Alternatively, as noted above, the control circuit (116) of the electronic device (100) can control the charged pigment display 214 directly.

In one embodiment, an optional touch sensor 220 is integrated with the charged pigment display 214 such that it becomes a touch-sensitive display. For example, the touch sensor 220 can comprise a capacitive touch sensor, which can be constructed by depositing small capacitive plate electrodes on a transparent substrate that spans the charged pigment display 214. The capacitive plate electrodes are configured to detect the presence of an object, such as a user's finger, near to or touching the charged pigment display by establishing electric field lines between pairs of capacitive sensors and then detecting perturbations of those field lines. The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Further, it is capable of being deposited in thin layers by way of a printing process. The capacitive sensors may also be deposited on the substrate by electron beam evaporation, physical vapor deposition, or other various sputter deposition techniques. Control circuitry, e.g., control circuit (116), the one or more control or driver circuits 217, or combinations thereof, can then detect a change in the capacitance of a particular plate to detect touch. Alternatively, the touch sensor 220 can be an infrared touch sensor or another touch-sensitive technology. Where the optional touch sensor 220 is included, the optional touch sensor 220 or the one or more control or driver circuits 217 can to deliver user input to the control circuit (116) of electronic device (100) when the touch-sensitive display is actuated. Accordingly, the control circuit (116) can control the one or more applications (105,106,107) with user input that is delivered to the charged pigment display 214 when the cover 204 is closed.

In one or more embodiments, the interface accessory 200 can include navigational buttons 240 in addition to, or rather than, the optional touch sensor 220. In such an embodiment, the user can touch the navigational buttons 240 on the interface accessory and corresponding user input can be communicated to the electronic device (100). Illustrating by example, a user might turn the page of an electronic book by touching a first button. The control circuit (116) of the electronic device (100) may map this user input to a particular function, such as “swipe left” in one or more embodiments. Similar mapping can occur for other buttons.

In one or more embodiments, rather than being disposed in the electronic device (100), the interface accessory 200 can include an optional position detector 221 to detect a rotational alignment of the cover 204 relative to the attachment portion 203 of the interface accessory 200. The position detector 221 or the one or more control or driver circuits 217 can then communicate the detected rotational alignment to the control circuit (116) of the electronic device (100). For instance, in one embodiment, the position detector 221 detects that a magnet 215,216 integrated with the cover 204 of the interface accessory 200 is in close proximity with, or abutting, the upper housing member (127) of the electronic device (100) as previously described.

Turning now to FIG. 4, illustrated therein is an alternate interface accessory 400 configured in accordance with one or more embodiments of the disclosure. This illustrative interface accessory 400 includes an attachment portion 403 and a cover 404. The attachment portion 403 is to attach to a housing (127,128) of an electronic device (100). While the attachment portion (203) of FIG. 2 was configured as a compartment to receive the electronic device (100), the attachment portion 403 of the interface accessory 400 of FIG. 4 attaches only to one side of the electronic device (100). The attachment mechanism could be friction fit, snap fit, magnetic, and so forth. This lack of a compartment results in the interface accessory 400 being sleeker and more streamlined in design by forfeiting the case or protective covering for the electronic device (100). The attachment portion 403 is illustrative only to provide an indication of various designs and configurations. Others will be obvious to those of ordinary skill in the art having the benefit of this disclosure.

As with the cover (204) of FIG. 2, the cover 404 of FIG. 4 is foldable relative to the attachment portion 403. In one embodiment, the cover 404 is foldable relative to the attachment portion 403 about an interconnection axis 410. Also, as with the cover (204) of FIG. 2, the cover 404 of FIG. 4 comprises a charged pigment display (not shown) disposed along the exterior portion of the cover 404. As no connector is provided, the interface accessory 400 of FIG. 4 could receive, for example, presentation instructions from the electronic device (100) by wireless communications as described above.

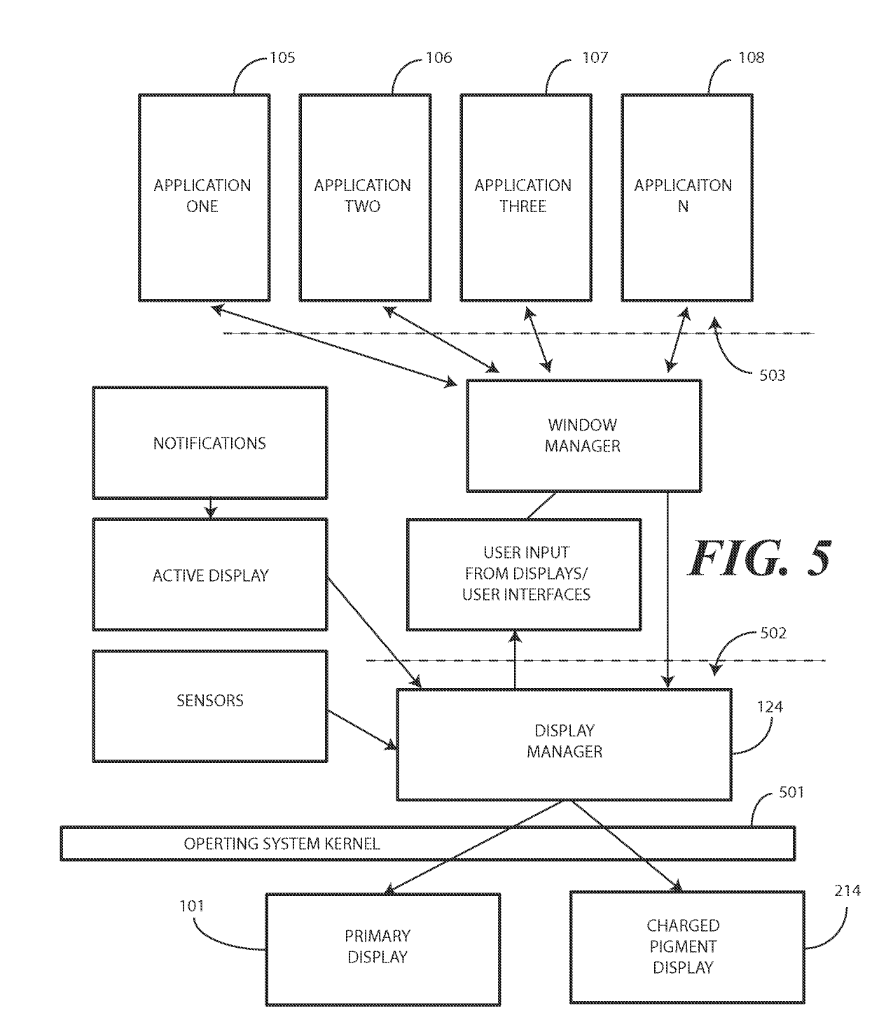

Turning briefly back to FIG. 1, in one embodiment the electronic device 100 includes a display manager 124 that is operable with the control circuit 116 at an operating system layer. The display manager 124 is to receive application presentation information from one or more applications (105,106,107,108) operating at an application layer. The display manager 124 is then to present the application presentation information on one or more of the display 101 or the charged pigment display (214) depending upon whether the cover (204) of the interface accessory is in the open position or the closed position. Turning now to FIG. 5, illustrated therein is a schematic diagram of how this interaction occurs.

As shown in FIG. 5, the display manager 124 operates at an operating system layer 502 with an operating system kernel 501. For example, in one embodiment the operating system kernel 501 comprises an Andriod.sup™ operating system. Applications 105,106,107,108 operate at an application layer 503. Examples of some applications 105,106,107,108 that can be operable in the application layer 503 include an e-mail application, a calendar application, a web browser application, a cellular call processing stack, user interface services software, a language pack, and so forth. Other software applications will be obvious to those of ordinary skill in the art having the benefit of this disclosure.

The display manager 124 serves as an interface between the display 101 and the charged pigment display (214) to receive application information from one or more of the applications 105,106,107,108 and to present the application information on one or more of the display 101 or the charged pigment display (214). Advantageously, placing the display manager 124 at the operating system layer 502 allows legacy applications to be used with the interface accessory (200) in that the legacy applications simply generate application information for presentation and are not aware of which display the application information is presented, as this is handled by the display manager 124. Said differently, inclusion of the display manager 124 means that an additional application is not required to drive information to the charged pigment display (214). To the contrary, the display manager 124 can function in the middleware of the operating system environment to render information output by applications appropriately for the capability of the charged pigment display (214).

In one embodiment, each application 105,106,107,108 generates application information in the form of a display graphics window. In one embodiment, the display graphics windows are two-dimensional windows. Illustrating by example, where an application 105 is a web browser, the corresponding display graphics window may be a web page configured for presentation on the display 101. The web page may include various links and active objects.

The display manager 124 receives this display graphics window and presents it on either the display 101 or the charged pigment display 214 depending upon whether the cover (204) conceals the display. If, for example, the cover (204) is in the closed position and the display manager 124 presents the display graphics window on the charged pigment display, the application 105 has no knowledge that the display graphics window is being rendered on a secondary display. Accordingly, no interface application or other tool to alter the display graphics window is required. This allows legacy applications to run normally with their output being presented on the charged pigment display 214 when the cover (204) is in the closed position.

Turning now to FIG. 7, illustrated therein is an alternate interface accessory 700 configured in accordance with one or more embodiments of the disclosure. This illustrative interface accessory 700 includes an attachment portion and a cover 704. The attachment portion is to attach to a housing (127,128) of an electronic device (100). As with the cover (204) of FIG. 2, the cover 704 of FIG. 7 is foldable relative to the attachment portion. The cover 704 of FIG. 7 comprises a charged pigment display 714 disposed along the exterior portion of the cover 704. In this embodiment, the cover 704 also comprises one or more user control devices 721,722,723 disposed along the exterior of the cover 704 to receive user input. The one or more user control devices 721,722,723 in FIG. 7 are configured as buttons. Alternatively, they may be configured as touch-sensitive user actuation targets disposed along the exterior of the cover 704. When a user actuates the one or more user control devices 721,722,723, user input can be delivered to the electronic device attached to the interface accessory 700 to control presentation information on the charged pigment display 714.

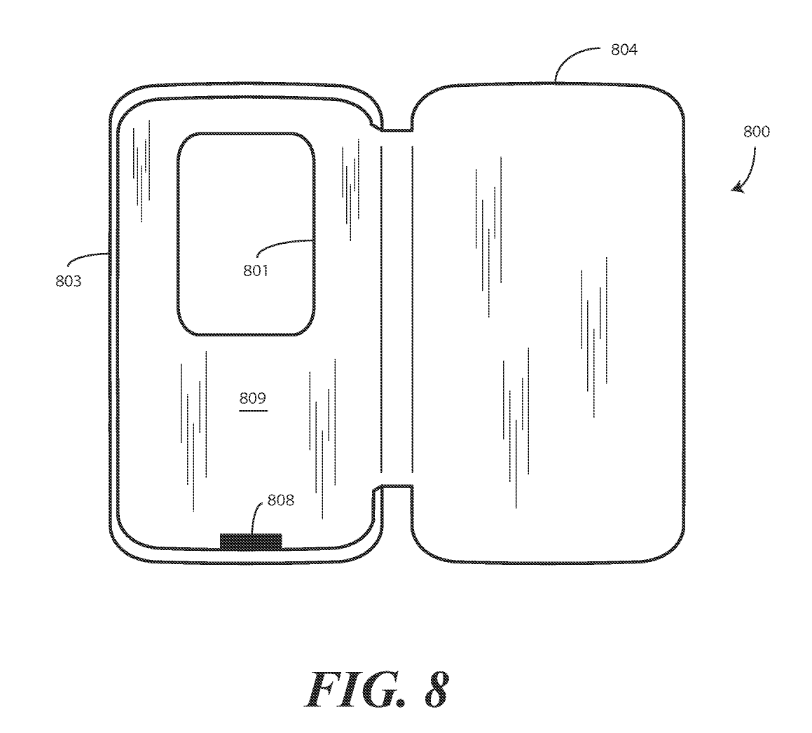

Turning now to FIG. 8, illustrated therein is another interface accessory 800 configured in accordance with one or more embodiments of the disclosure. The interface accessory 800 includes an attachment portion 803 and a cover 804. The attachment portion 803 is to attach to a housing (127,128) of an electronic device (100). In this illustrative embodiment, the attachment portion 803 is configured as a compartment to receive the electronic device (100). This results in the interface accessory 800 being configured as a case or protective covering for the electronic device (100). A complementary connector 808 is included for attachment to the connector (113) of the electronic device (100).

In this embodiment, the rear panel 809 of the interface accessory 800 includes an aperture 801 through which a rear side of the electronic device (100) will be accessible when the attachment portion 803 is attached to the housing (127,128) of the electronic device (100). The aperture is included because embodiments of the disclosure contemplate that the rear side of an electronic device can include user controls as described above. Specifically, as mentioned above, features can be incorporated into the housing members of the electronic device (100), including control buttons (109,110), a camera (111), and an optional speaker port (114). Providing the aperture 801 in the rear panel 809 of the interface accessory 800 allows these features to be accessed. This provides an advantage over prior art designs in that incorporation of the charged pigment display with the cover 804 frees the rear panel 809 of components so that the aperture can be included.

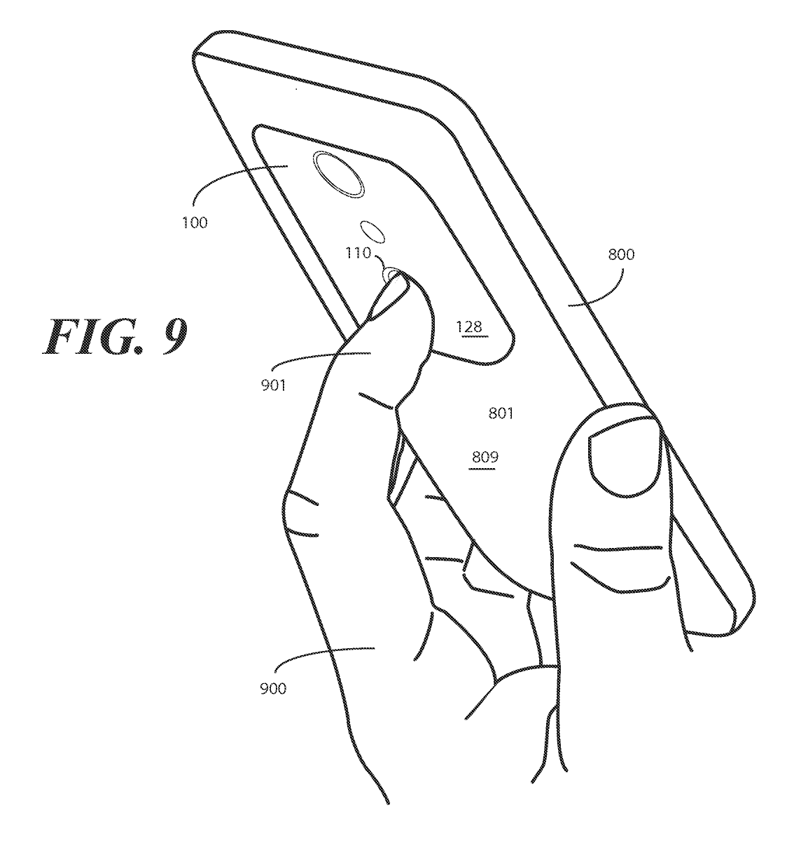

Turning now to FIG. 9, a user 900 is shown actuating a control device 110 by placing a finger 901 into the control device 110. A major face defined by the rear housing 128 includes the control device 110, which in one embodiment is defined by a touch sensitive surface disposed along the major face. In one embodiment, the touch sensitive surface defines an area configured with a touch sensor to detect the presence of an object, such as a user's finger or stylus, when that object is proximally located with a surface of the touch sensitive surface. In one or more embodiments, the touch sensitive surface is defined by a capacitive touchpad that spans the touch sensitive surface. The capacitive touchpad can be constructed in a variety of ways. For example, in one embodiment the capacitive touchpad is formed by horizontal conductors and vertical conductors that cross over each other to define a grid of pixels. One set of conductors can be coupled to a touch driver, operable with the control circuit, which delivers a signal to each pixel of the grid. Electrical charges then travel to the pixels of the grid. Electromagnetic fields are then created about the pixels. The fields are altered by interaction of a user's finger or other conductive object interacting with the touch sensitive surface. This alteration allows the control circuit to detect touch input.

Advantageously, the user 900 is able to access the control device 110 because the aperture 801 is present in the rear panel 809 of the interface accessory 800. This allows, for example, the user 900 to control the presentation information being presented on the charged pigment display of the interface accessory in this illustrative embodiment.

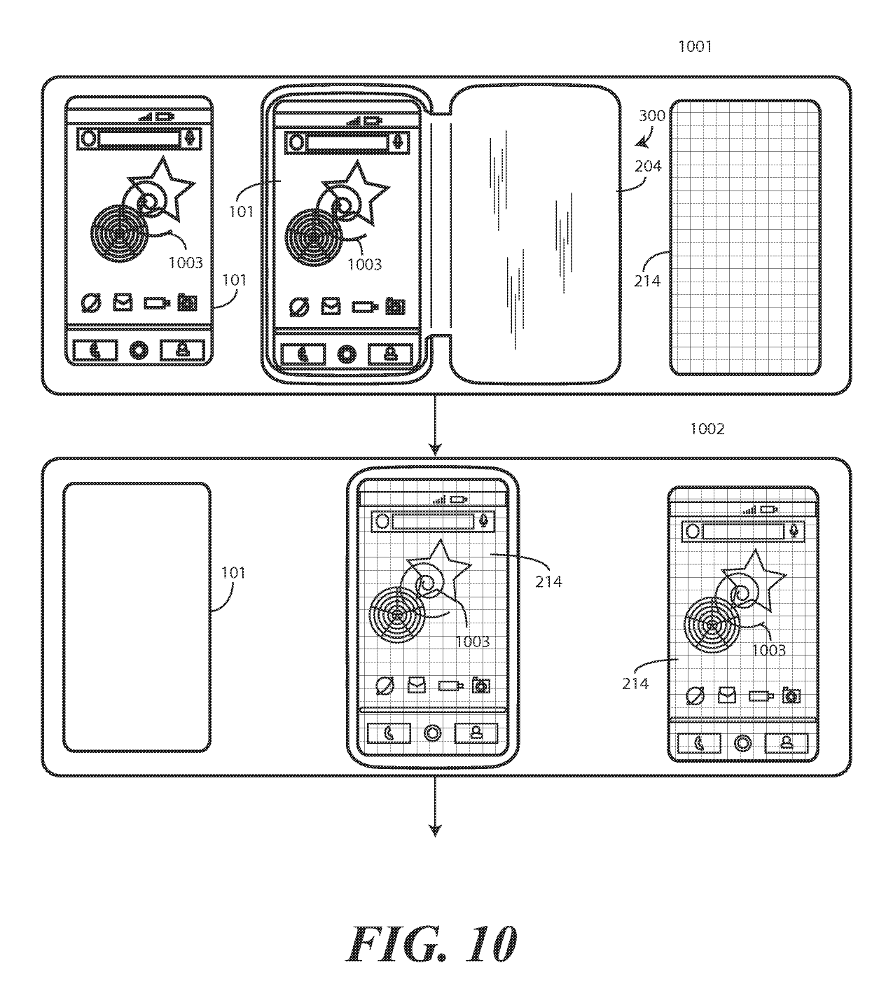

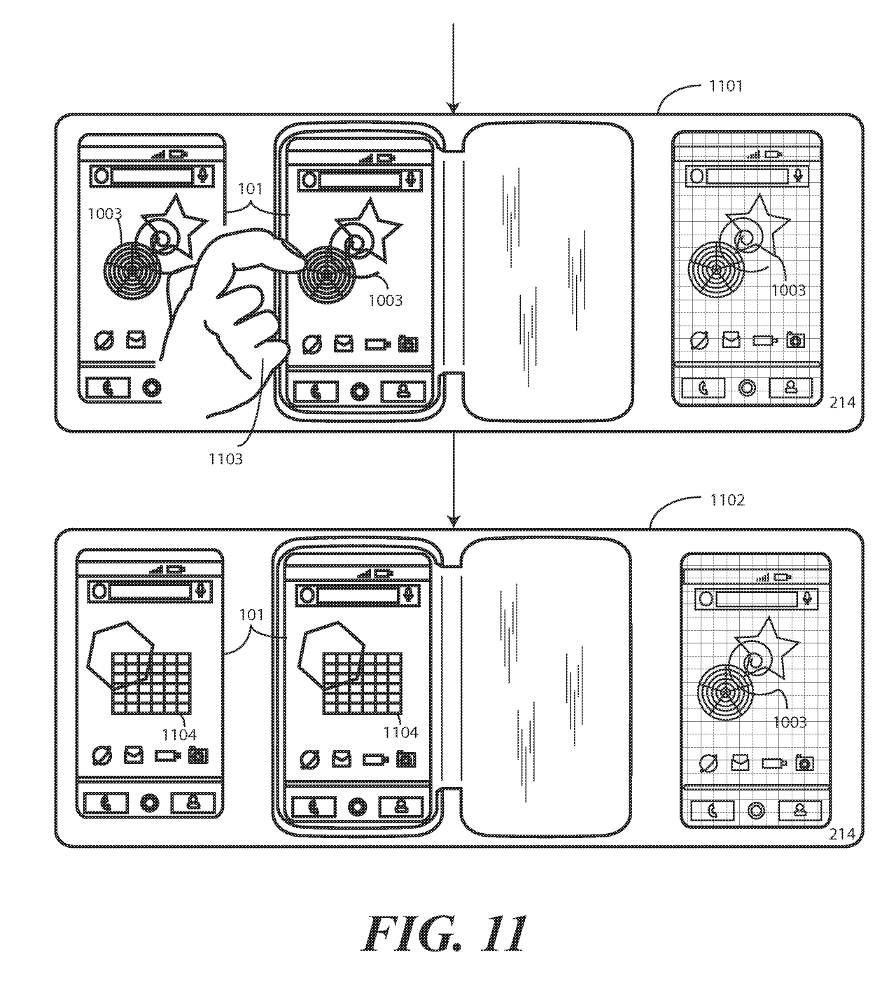

Turning now to FIGS. 10-11, illustrated therein is one explanatory method of using a system 300 in accordance with one or more embodiments of the disclosure. The system 300 is shown in the middle of each step, with the display 101 presented to the left and the charged pigment display 214 presented to the right. The display 101 and the charged pigment display 214 are shown independently so that each may be seen when the cover 204 is in the closed position or open position, respectively.

At step 1001, the cover 204 is in the open position. Presentation information 1003 is being presented on the display 101. No information is being presented on the charged pigment display 214.

At step 1002, the cover 204 has been rotated to the closed position. Accordingly, one or more control circuits, be they in the electronic device 100, the interface accessory 200, or combinations thereof, replicate the presentation information 1003 on the charged pigment display 214. In one embodiment, this replication occurs automatically when the cover 204 is closed. In one embodiment, this replication occurs only when the cover is closed 204. In one embodiment, the resolution of the presentation information 1003 is exactly the same as it was on the display 101 prior to replication. The display 101, which is no longer visible to the user, is placed in a low-power mode at step 1002.

Turning now to FIG. 11, at step 1101 the cover 204 has been rotated to the open position.

The control circuits thus bring the display 101 out of the low-power mode and again present the presentation information 1003 on the display 101. As the charged pigment display 214 is electrophoretic in one embodiment, the presentation information 1003 remains there when the cover 204 is opened. In one embodiment, a user selectable setting is provided so that the presentation information 1003 is erased from the charged pigment display 214 when the cover 204 is rotated to the open position.

At step 1101, a user 1103 is interacting with the display 101 by providing touch input to the display 101. This causes a change in presentation information as shown in step 1102, where the presentation information 1104 presented on the display 101 has changed. As the charged pigment display 214 is inactive while the cover 204 is in the open position in this example, the presentation information 1003 presented there is the same as it was before.

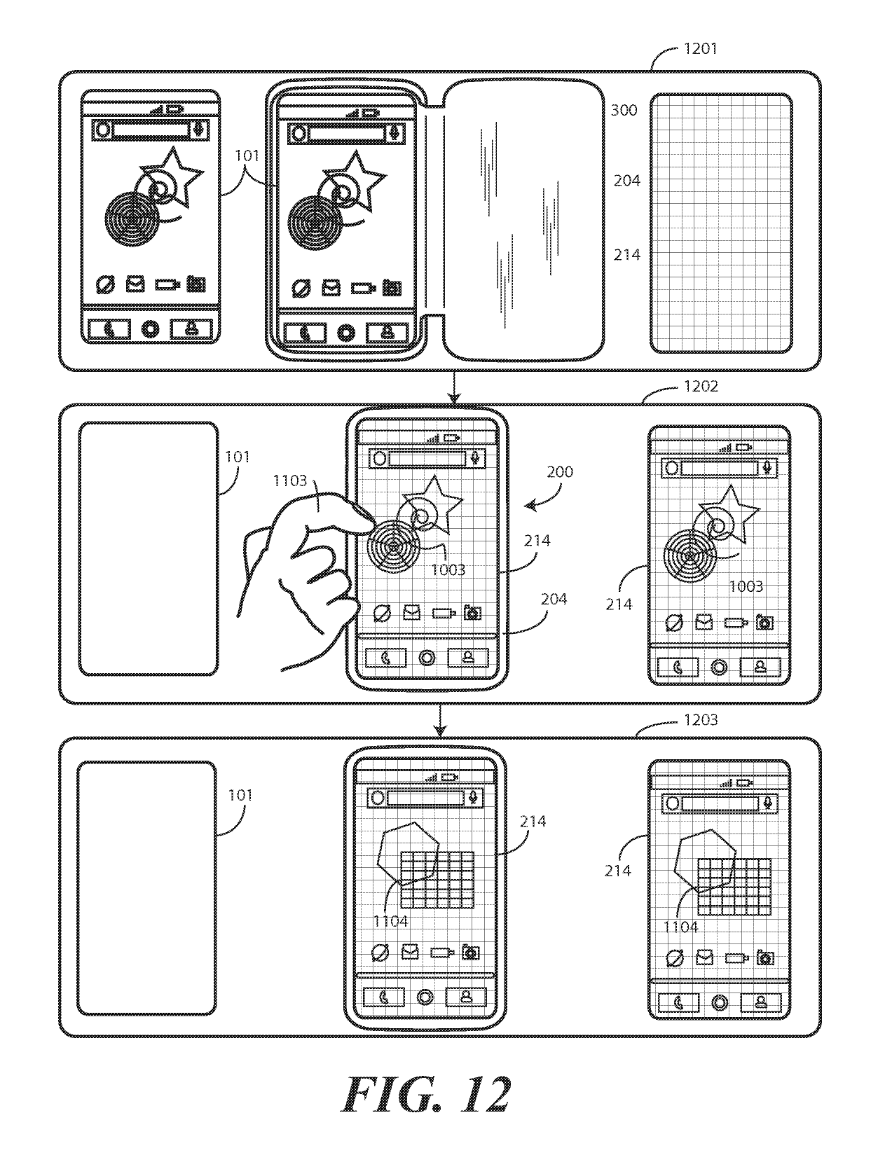

Turning now to FIG. 12, illustrated therein is another method for using a system 300 configured in accordance with one or more embodiments of the disclosure. At step 1201, the cover 204 is in the open position. Presentation information 1003 is being presented on the display 101. No information is being presented on the charged pigment display 214.

At step 1202, the cover 204 has been rotated to the closed position. Accordingly, one or more control circuits, be they in the electronic device, the interface accessory 200, or combinations thereof, replicate the presentation information 1003 on the charged pigment display 214. In one embodiment, this replication occurs automatically when the cover 204 is closed. In one embodiment, this replication occurs only when the cover is closed 204. In one embodiment, the resolution of the presentation information 1003 is exactly the same as it was on the display 101 prior to replication. The display 101, which is no longer visible to the user, is placed in a low-power mode at step 1002.

At step 1202, a user 1103 is interacting with the charged pigment display 214, which is touch sensitive in this embodiment, by providing touch input to the charged pigment display 214. This causes a change in presentation information as shown in step 1203, where the presentation information 1104 presented on the charged pigment display 214 has changed. As the display 101 is in a low-power mode is inactive while the cover 204 is in the closed position in this example, nothing is presented on the display 101.

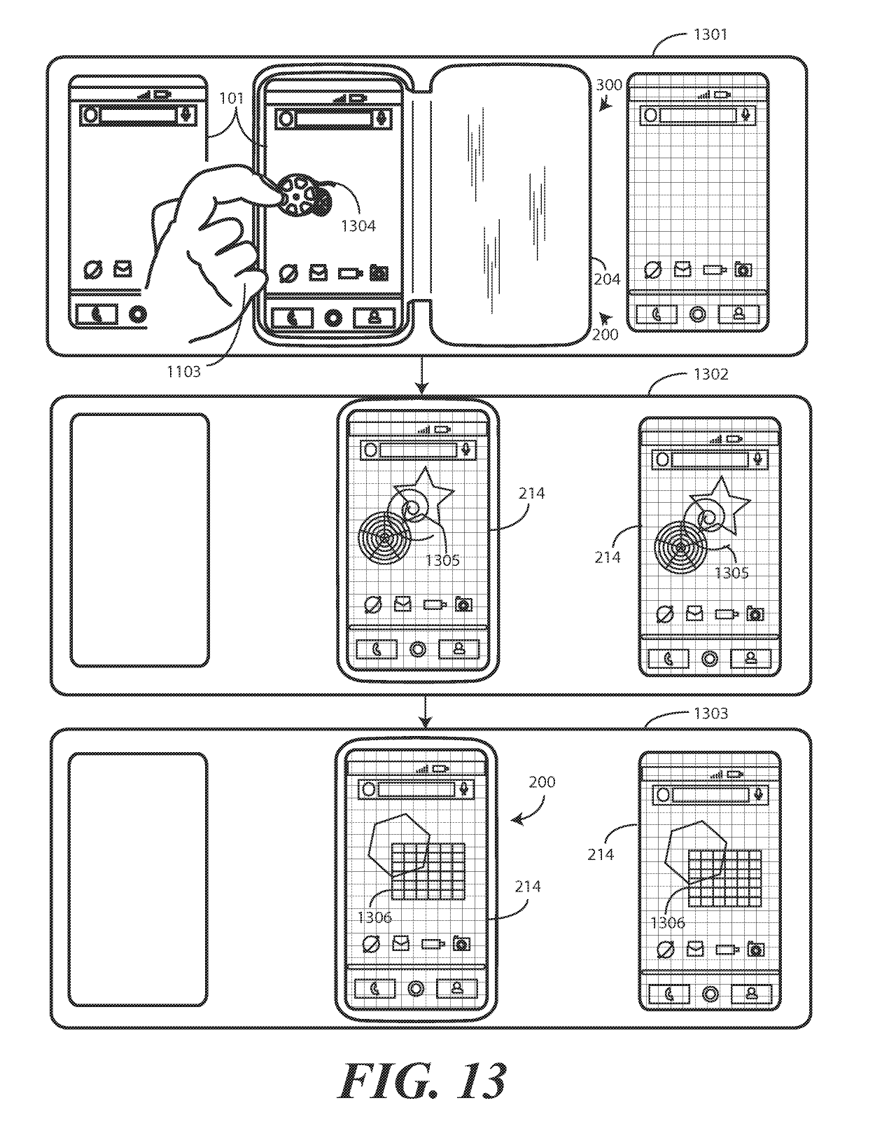

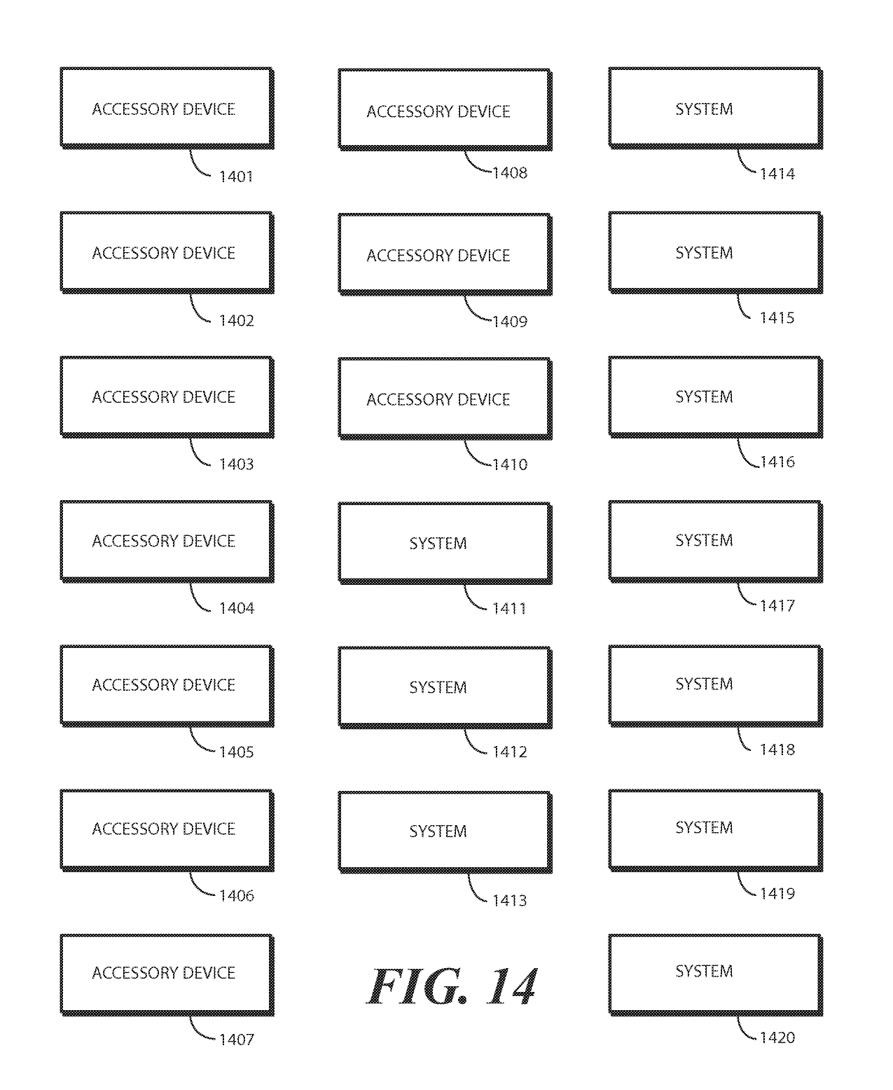

To illustrate that the presentation information can include video, FIG. 13 provides yet another method for using a system 300 in accordance with one or more embodiments of the disclosure. At step 1301, a user 1103 selects a video 1304 for presentation. The user 1103 then closes the cover 204 of the accessory device such that it conceals the display 101 of the electronic device.

At step 1302, the video 1304 starts playing. A first scene 1305 is presented on the charged pigment display 214. The display manager (124) then continues to deliver the video 1304 to the charged pigment display 214, which refreshes at a rate sufficient for the video to render on the charged pigment display 214. Accordingly, a second scene 1306 then appears on the charged pigment display 214 at step 1303. This process continues while the video is playing. Advantageously, this allows the user to even watch video in full sun due to the provision of an additional display technology by the interface accessory 200.

Turning now to FIG. 14, illustrated therein are various embodiments of the disclosure. At 1401, an interface accessory for an electronic device comprises an attachment portion to attach to a housing of the electronic device. At 1401, the interface accessory comprises a cover to conceal a display of the electronic device. At 1401, the cover comprises a charged pigment display disposed along an exterior portion of the cover. At 1401, one or more circuits, operable with the charged pigment display, and which may be disposed in the interface accessory or an electronic device coupled thereto, are to receive display presentation instructions from the electronic device to replicate presentation information from the display on the charged pigment display.

At 1402, the attachment portion of 1401 comprises compartment to receive the electronic device. At 1402, the cover is foldable about an interconnection axis with the compartment. At 1403, the cover and the charged pigment display of 1402 are pliable.

At 1404, the one or more circuits of 1401 are to detect a rotational alignment of the cover relative to the attachment portion and to communicate the rotational alignment to the electronic device. At 1405, the interface assembly of 1401 further comprises a connector, operable with the one or more circuits and disposed along the attachment portion. At 1405, the one or more circuits of 1401 are to receive the display presentation instructions through the connector. At 1406, the resolution of the charged pigment display and the display of 1401 are the same.

At 1407, the one or more circuits of 1401 are to replicate the presentation information from the display on the charged pigment display only when the cover conceals the display. At 1408, the one or more circuits of 1401 are to automatically replicate the presentation information from the display on the charged pigment display when the cover conceals the display.

At 1409, the charged pigment display of 1401 comprises a touch-sensitive display. At 1409, the one or more circuits of 1401 are to deliver user input to the electronic device when the touch-sensitive display is actuated. At 1410, touch-sensitive display of 1409 comprises a capacitive touch sensor.

At 1411, a system comprises an electronic device. At 1411, the electronic device comprises a housing, a display disposed along a major face of the housing, and one or more circuits operable to present information on the display. At 1411, the system includes an interface accessory to attach to the housing. At 1411, the interface accessory comprises a cover and a charged pigment display disposed along an exterior of the cover. At 1411, the cover is foldable to conceal the display. At 1411, the one or more circuits to replicate the information on the charged pigment display.

At 1412, the system of 1411 includes a connector disposed along the housing. At 1412, the connector is coupled with the one or more circuits of 1411. At 1412, a complementary connector is disposed along the interface accessory. At 1412, the one or more circuits of 1411 are to replicate the information on the charged pigment display when the complementary connector is coupled to the connector.

At 1413, the system of 1411 further comprises a display manager operable with the one or more circuits at an operating system layer. At 1413, the display manager is to receive application presentation information from one or more applications operating at an application layer. At 1413, the display manager is to present the application presentation information on one or more of the display or the charged pigment display.

At 1414, the one or more circuits of 1411 are to detect whether the cover conceals the display and to automatically replicate the information on the charged pigment display when the cover conceals the display. At 1415, the one or more circuits of 1411 are to place the display in a low-power mode when the cover conceals the display.

At 1416, the charged pigment display of 1411 is touch-sensitive. At 1416, the one or more circuits of 1411 are to control one or more applications with user input delivered to the charged pigment display.

At 1417, the electronic device of 1411 comprises a touch-sensitive surface disposed along a second major face of the housing. At 1417, the interface accessory of 1411 defines an aperture through which the touch-sensitive surface is accessible when the interface accessory is attached to the housing.

At 1418, the display and the charged pigment display of 1411 have a common resolution.

At 1419, the cover of 1411 further comprises one or more user control devices disposed along the exterior of the cover to receive user input. At 1420, the interface accessory of 1411 comprises a case for the electronic device.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. For example

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

What is claimed is:

1. An interface accessory for an electronic device, comprising:
an attachment portion to attach to a housing of the electronic device;
a cover to conceal a display of the electronic device, the cover comprising another display disposed along an exterior portion of the cover; and
one or more circuits, operable with the display, to receive display presentation instructions from the electronic device to replicate presentation information from the display on the another display.

2. The interface accessory of claim 1, the attachment portion comprising a compartment to receive the electronic device, the cover foldable about an interconnection axis with the compartment.

3. The interface accessory of claim 2, the another display comprising a pliable charged pigment display.

4. The interface accessory of claim 1, the one or more circuits to detect a rotational alignment of the cover relative to the attachment portion and to communicate the rotational alignment to the electronic device.

5. The interface accessory of claim 1, further comprising a connector, operable with the one or more circuits and disposed along the attachment portion, the one or more circuits to receive the display presentation instructions through the connector.

6. The interface accessory of claim 1, a resolution of the another display and the display are the same.

7. The interface accessory of claim 1, the one or more circuits to replicate the presentation information from the display on the another display only when the cover conceals the display.

8. The interface accessory of claim 1, the one or more circuits to automatically replicate the presentation information from the display on the another display when the cover conceals the display.

9. The interface accessory of claim 1, the another display comprising a touch-sensitive charged pigment display, the one or more circuits to deliver user input to the electronic device when the touch-sensitive charged pigment display is actuated.

10. The interface accessory of claim 1, the interface accessory comprising one or more navigational buttons to receive user input to control the electronic device.

11. A system, comprising:
an electronic device comprising:
a housing;
a display disposed along a major face of the housing; and
one or more circuits operable to present information on the display; and
an interface accessory to attach to the housing, the interface accessory comprising a cover and a charged pigment display disposed along an exterior of the cover, the cover foldable to conceal the display;
the one or more circuits to one of replicate or pseudo-replicate the information on the charged pigment display.

12. The system of claim 11, further comprising:
a connector disposed along the housing, the connector coupled with the one or more circuits; and
a complementary connector disposed along the interface accessory;
the one or more circuits to replicate the information on the charged pigment display when the complementary connector is coupled to the connector.

13. The system of claim 11, further comprising a display manager operable with the one or more circuits at an operating system layer, the display manager to receive application presentation information from one or more applications operating at an application layer, and to present the application presentation information on one or more of the display or the charged pigment display.

14. The system of claim 11, the one or more circuits to detect whether the cover conceals the display and to automatically replicate the information on the charged pigment display when the cover conceals the display.

15. The system of claim 14, the one or more circuits to place the display in a low-power mode when the cover conceals the display.

16. The system of claim 11, the charged pigment display being touch-sensitive, the one or more circuits to control one or more applications with user input delivered to the charged pigment display.

17. The system of claim 11, the electronic device comprising a touch-sensitive surface disposed along a second major face of the housing, the interface accessory defining an aperture through which the touch-sensitive surface is accessible when the interface accessory is attached to the housing.

18. The system of claim 11, the display and the charged pigment display having a common resolution.

19. The system of claim 11, the cover further comprising one or more user control devices disposed along the exterior of the cover to receive user input.

20. The system of claim 11, the interface accessory comprising a case for the electronic device.
